(19) United States
(12) Patent Application Publication
(10) Pub. No.: US 2025/0351966 A1
(43) Pub. Date: Nov. 20, 2025

(54) MOLDED SEAT

(71) Applicant: Custom-Pak, Inc., Clinton, IA (US)

(72) Inventors: Wayne Johnston, Camanche, IA (US); Pamela Naeve, Clinton, IA (US)

(21) Appl. No.: 19/208,009

(22) Filed: May 14, 2025

Related U.S. Application Data
(60) Provisional application No. 63/647,865, filed on May 15, 2024.

(51) Int. Cl. A47C 7/16; B60N 2/68

(52) U.S. Cl. CPC A47C 7/16; B60N 2/686

(57) ABSTRACT

A molded seat comprising a molded seat pan having a seat portion and a molded seat insert configured to engage the seat portion of the molded seat pan. The molded seat insert may have a lower surface defining at least one lower recess and an upper surface defining at least one upper recess. The at least one upper recess and the at least one lower recess may be at least partially aligned with each other. The molded seat pan may also have a backrest portion, and a molded backrest insert may be mounted thereto.

### CROSS-REFERENCE TO RELATED APPLICATIONS

This application claims the benefit of U.S. Provisional Application Ser. No. 63/647,865, filed May 15, 2024, the complete disclosure of which is incorporated herein by reference for all purposes.

### FIELD OF THE INVENTION

The present invention relates to molded seats and more specifically, relates to molded seats that have molded components that together provide adequate cushioning and stiffness.

### BACKGROUND OF THE INVENTION

There are various types of molding processes that are generally known in the art. For example, there include various molding processes such as injection molding, rotational molding, or various types of thermoforming such as vacuum forming or pressure forming. Another type of molding is blow molding, there also being a variety of different blow-molding processes, such as extrusion blow-molding, injection blow-molding, or stretch blow-molding.

The use of blow-molding, by example, provides a method for manufacturing various sorts of articles that typically involves the use of a mold consisting of two separate halves or portions having cavities of particularly desired shapes and sizes. Usually, one extrudes a large-diameter, sealed tube of molten material (commonly referred to as a “parison”), places the parison between the mold halves, and closes the mold around the parison. The parison is often made of a thermoplastic material. Fluid pressure is then introduced into the parison via an opening, forcing the molten parison against the walls of the cavities, conforming the parison to the shape thereof. The pressure is maintained until the molten material cools and solidifies. The pressure is then released, the mold halves are pulled apart, and the hardened article is ejected therefrom.

Blow-molded seats, such as for bar stools, for vehicles such as tractors and lawnmowers, of for any other seating need, can offer simple and cost-effective manufacturability. A wide variety of different thermoplastic materials, each having unique material properties, may be employed in the manufacture of seats via these molding processes, but seats manufactured via a molding process are typically challenges by the competing desire to provide adequate stiffness to support a user while also providing adequate softness to ensure the user's comfort while seated (especially while seated for extended periods of time). The desire for providing adequate support may typically outweigh the desire for softness, often causes significant sitting comfort issues for the seat user.

In order to improve comfort, conventional seats manufactured via a molding process, e.g., a blow molded process, may add padding, e.g., upholstered padding to the horizontal seating and vertical backrest surfaces. This padding may be, e.g., sponge rubber or foam, and is typically glued to the molded portions of the seat, and then the padding may be covered by, e.g., vinyl or some other covering materials.

However, these conventional seats that employ both upholstered padding and molded seat components have several disadvantages. For example, the process employed to bond the upholstered portions of the seat to the molded portion of the seat may require additional manufacturing materials, e.g., bonding glue, may require additional manufacturing steps to perform the bonding process, may require additional personnel to perform such additional manufacturing steps, may require additional time to allow for the bonding materials to set, any one of which or all of which may increase production costs undesirably.

Furthermore, conventional seats that employ both upholstered padding and molded seat components may have further disadvantages. For example, the padding in these seats may be subject to tearing, premature wear, and detachment, requiring replacement of the entire seat. If covered in, e.g., vinyl, such vinyl may become stress-cracked, creating an opening for water that may ultimately result in cushion fatigue and seat failure. Still further, the padding material can retain moisture, providing an undesirable seat surface to a user and/or potentially resulting in mold.

Thus, there is a need for a seat the provides the comfort of padding with the advantages of blow molding.

### SUMMARY OF THE INVENTION

The following presents a simplified summary of the claimed subject matter in order to provide a basic understanding of some aspects of the claimed subject matter. This summary is not an extensive overview of the claimed subject matter. It is intended to neither identify key or critical elements of the claimed subject matter nor delineate the scope of the claimed subject matter. Its sole purpose is to present some concepts of the claimed subject matter in a simplified form as a prelude to the more detailed description that is presented later.

In accordance with various embodiments thereof, systems and methods are provided for manufacturing a molded seat. In an embodiment, there is provided a molded seat that includes a molded seat pan having a seat portion. There is also provided, a molded seat insert configured to engage the seat portion of the molded seat pan. The molded seat insert may have a lower surface defining at least one lower recess and an upper surface defining at least one upper recess. In embodiments, the at least one upper recess and the at least one lower recess may be at least partially aligned with each other, while in other embodiments, the at least one upper recess and the at least one lower recess may be fully aligned with each other. In embodiments, the lower surface of the molded seat insert may define three lower recesses and the upper surface of the molded seat insert may define three upper recesses, and the lower recesses may be aligned with the upper recesses.

In addition, the molded seat pan may have a backrest portion. The molded backrest insert may be mounted to the backrest portion of the molded seat pan. The molded backrest insert may have a back surface defining at least one back recess and a front surface defining at least one front recess. The at least one back recess and the at least one front recess may be at least partially aligned with each other. In embodiments, the back surface of the molded backrest insert may define three back recesses and the front surface of the molded backrest insert may define three front recesses, the back recesses being aligned with the front recesses.

The at least one lower recess and the at least one upper recess may have various cross-sectional shapes, including for example, may have channel-shaped, e.g., U-shaped, cross-sections. Other cross-sectional shapes of the lower and upper recesses are also contemplated. In embodiments, the at least one lower recess may be deeper than the at least one upper recess. For example, in embodiments, the at least one lower recess and the at least one upper recess may each include three recesses, and the three upper recesses may have a depth that is substantially the same as each of the other upper recessed, and the three lower recesses have depths that are progressively deeper relative to each other towards a front edge of the molded seat insert. In this way, there may be provided additional rigidity and/or stiffness nearer to the rear edge of the molded seat insert where more of a user's weight may be supported, and additional softness and/or comfort nearer to the front edge of the molded seat insert where a user may feel discomfort in the legs after long periods of sitting on the molded seat insert.

In still further embodiments, the at least one lower recess on the lower surface of the molded seat insert may have a pair of ends that each extend from a front edge of the molded seat insert towards a rear edge of the molded seat insert. Additionally or alternatively, the at least one lower recess on the lower surface of the molded seat insert may have a pair of ends that each extend from opposite side edges of the molded seat insert towards a rear edge of the molded seat insert. Additionally or alternatively, the at least one lower recess on the lower surface of the molded seat insert may have a pair of ends that each extend from opposite front corners of the molded seat insert towards a rear edge of the molded seat insert. In still other embodiments, such as the embodiment described herein below, the upper and lower surfaces of the molded seat insert may have three upper and three lower recesses, with a first set of upper and lower recesses each having a pair of recess end regions that extend from a front edge of the molded seat insert towards a rear edge of the molded seat insert, a second set of upper and lower recesses each having a pair of end regions that extend from opposite side edges of the molded seat insert towards a rear edge of the molded seat insert, and a third set of upper and lower recesses each having a pair of end regions that extend from opposite front corners of the molded seat insert towards a rear edge of the molded seat insert.

In embodiments, the molded seat pan may be molded from a first thermoplastic, and the molded seat insert may be molded from a second thermoplastic, and the first thermoplastic may have a stiffness that is greater than a stiffness of the second thermoplastic. Advantageously, although not being limited thereto, one or all of the molded seat pan, the molded seat insert and the molded backrest insert may be blow-molded. In still other embodiments, at least one or all of the molded seat pan, the molded seat insert and the molded backrest insert may be pressurized and sealed so that it provides additional cushioning when a user sits thereon.

There is also provided herein, according to various embodiments, a molded insert. The molded insert may include one or both of a molded seat insert and a molded backrest insert. In either case, the molded seat insert and/or the molded backrest insert may be configured to engage a seat pan, such as a molded seat pan insert. Using a molded seat insert as an example (although a molded backrest insert may also be contemplated in addition to or instead), the molded seat insert may include an upper surface that may define at least one upper recess, a lower surface that may define at least one lower recess, wherein the at least one upper recess and the at least one lower recess may be at least partially aligned with each other. In embodiments, the lower surface of the molded seat insert may define three lower recesses and the upper surface of the molded seat insert may define three upper recesses, and the lower recesses may be aligned with the upper recesses.

In embodiments, the at least one lower recess and the at least one upper recess may have various cross-sectional shapes, including for example, may have channel-shaped, e.g., U-shaped, cross-sections. The at least one lower recess may be deeper than the at least one upper recess. In embodiments, the upper and lower surfaces of the molded seat insert may each include three recesses, wherein the three upper recesses may have a depth that is substantially the same as each other, and wherein the three lower recesses may have depths that are progressively deeper relative to each other towards a front edge of the molded seat insert.

Still further, in embodiments, the at least one upper and lower recesses of the molded seat insert may have a pair of end regions that each extend from a front edge of the molded seat insert towards a rear edge of the molded seat insert. Additionally or alternatively, the at least one upper and lower recesses may have a pair of end regions that each extend from opposite side edges of the molded seat insert towards a rear edge of the molded seat insert. Additionally or alternatively, the at least one upper and lower recesses may have a pair of ends that each extend from opposite front corners of the molded seat insert towards a rear edge of the molded seat insert. Still further, the upper and lower surfaces of the molded seat insert may have one or more, or even all, of these upper and lower recess configurations.

In embodiments, the molded seat insert may be molded from a thermoplastic, which may be a relatively softer thermoplastic so as to provide additional comfort to a user. Advantageously, the molded seat insert may be blow-molded, and in some embodiments, the molded seat insert may have openings to the external atmosphere, so as to be able to breathe when sat upon, or the molded seat insert may be sealed, e.g., either at atmospheric pressure within its sealed interior or pressurized within its sealed interior so as to provide still further cushioning when sat upon.

### BRIEF DESCRIPTION OF THE FIGURES

FIG. 1 is a front perspective view of a molded seat having a molded seat pan, and having a molded seat insert and a molded backrest insert mounted thereon, in accordance with various embodiments;

FIG. 2 is a side view of the molded seat of FIG. 1, in accordance with various embodiments;

FIG. 3 is a bottom view of the molded seat of FIG. 1, in accordance with various embodiments;

FIG. 4 is a top view of the molded seat of FIG. 1, in accordance with various embodiments;

FIG. 5 is a front perspective view of a molded seat pan of FIG. 1, having the molded seat insert and the molded backrest insert removed, in accordance with various embodiments;

FIG. 6 is a rear view of the molded seat insert and the molded backrest insert of FIG. 1, having been removed from the seat pan, in accordance with various embodiments;

FIG. 7 is a side perspective view of the molded seat of FIG. 1, having the molded seat pan and with the molded seat insert and molded backrest insert mounted thereon, with the molded seat pan, the molded seat insert, and the molded backrest insert shown in cross-section, in accordance with various embodiments;

FIG. 8 is a front perspective view of the molded seat of FIG. 1, having the molded seat pan and with the molded seat insert and molded backrest insert mounted thereon, with the molded seat pan and the molded seat insert shown in cross-section, in accordance with various embodiments; and

FIG. 9 is a top perspective view of the molded seat of FIG. 1, having the molded seat pan and with the molded seat insert and molded backrest insert mounted thereon, with the back portion of the molded seat pan and the molded backrest insert shown in cross-section, in accordance with various embodiments.

### DETAILED DESCRIPTION

Reference will now be made in detail to specific embodiments illustrated in the accompanying drawings. In the following detailed description, numerous specific details are set forth to provide a thorough understanding. However, it will be apparent to one of ordinary skill in the art that embodiments may be practiced without these specific details. In other instances, known methods, procedures and components have not been described in detail so as not to unnecessarily obscure aspects of the embodiments.

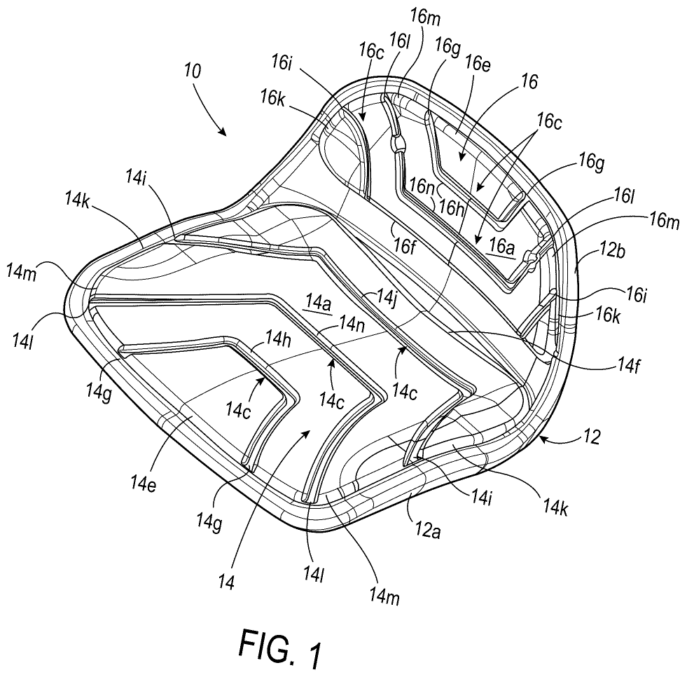

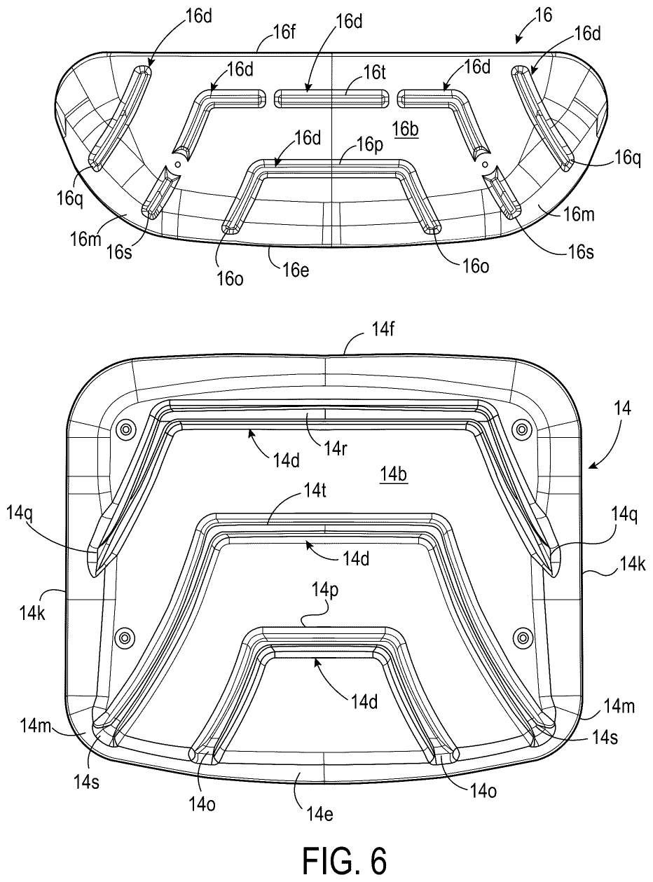

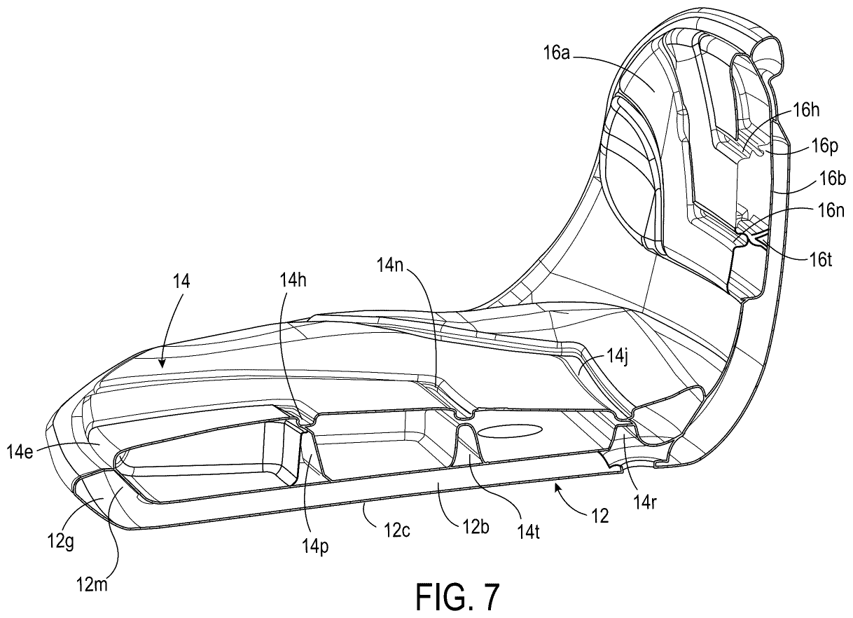

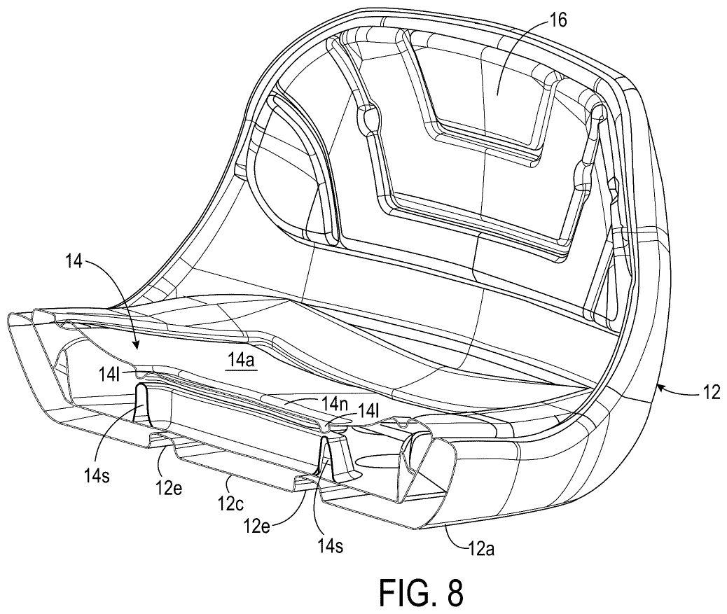

As set forth above, FIG. 1 is a front perspective view of a molded seat having a molded seat pan, and having a molded seat insert and a molded backrest insert mounted thereon, in accordance with various embodiments. As shown in FIG. 1, there is provided a molded seat 10. The molded seat 10 includes a molded seat pan 12 having a seat portion 12a and backrest portion 12b. Attached to or mounted on the molded seat pan 12 is a molded seat insert 14 which is configured to engage, e.g., rest within and/or be fixedly attached to, the seat portion 12a of the molded seat pan 12. The molded seat insert 14 has an upper surface 14a defining various upper recesses 14c. The molded seat insert 14 also has a lower surface 14b, best shown in FIG. 6. FIG. 6 is a rear view of the molded seat insert 14 and a molded backrest insert 16, explained further below, of FIG. 1, having been removed from the molded seat pan 12, in accordance with various embodiments). As shown in FIG. 6, there lower surface 14b of the molded seat insert 14 defines various lower recesses 14d. As will be best shown in FIGS. 7 and 8, which are explained in greater detail below, the upper recesses 14c and lower recesses 14d of the molded seat insert 14 may be being at least partially aligned, and advantageously are fully aligned, e.g., aligned in the vertical direction, with each other to provide improved support as well as cushioning (in addition to the benefit of recesses generally in potentially reducing the amount of material needed to form a part and thus potentially reducing its cost).

As shown in FIG. 1 (and in FIG. 6), the molded seat insert 14 has three upper and lower recesses 14c, 14d, although any number of upper and lower recesses 14c, 14d are contemplated. It should also be noted that, while FIG. 1 and FIG. 6 show an embodiment in which the molded seat insert 14 has an equal number, e.g., three, of upper and lower recesses 14c, 14d, it is also contemplated that there may be a different number of upper recesses 14c as compared to the number of lower recesses 14d.

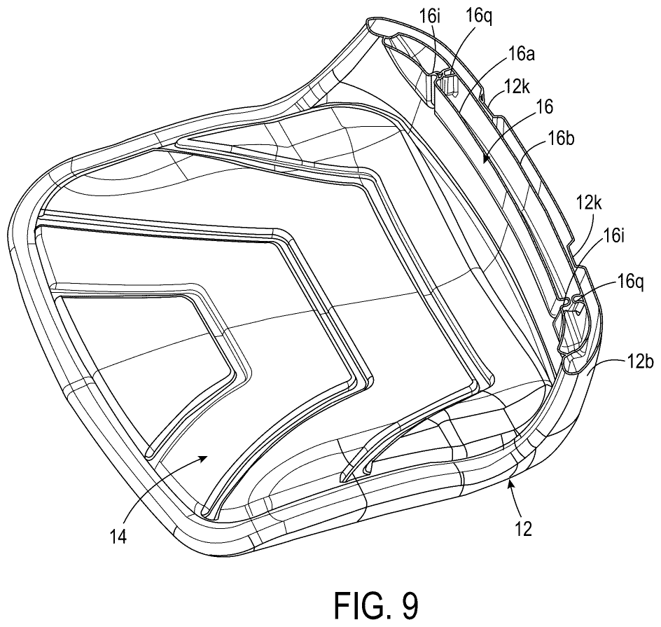

As shown in FIG. 1, the molded seat pan 12 also has a backrest portion 12b. Attached to or mounted on the backrest portion 12b of the molded seat pan 12 is a molded backrest insert 16, which may be a separate component from the molded seat insert 14 as shown herein, or which alternatively may be connected to or a part of the molded seat insert 14. The molded backrest insert 16 has a back surface 16b (also best shown in FIG. 6, which also shows the back surface 16b of the molded backrest insert 16 defining various back recesses 16d) and a front surface 16a defining various front recesses 16c. As will be best shown in FIG. 9, which is explained in greater detail below, the front recesses 16c and back recesses 16d of the molded backrest insert 16 may be being at least partially aligned, and advantageously are fully aligned, e.g., aligned in the horizontal direction, with each other.

As shown in FIG. 1 (and in FIG. 6), the molded backrest insert 16 has three front and back recesses 16c, 16d, although any number of front and back recesses 16c, 16d are contemplated. Similar to above, it should also be noted that, while FIG. 1 and FIG. 6 show an embodiment in which the molded backrest insert 16 has an equal number, e.g., three, of front and back recesses 16c, 16d, it is also contemplated that there may be a different number of front recesses 16c as compared to the number of back recesses 16d.

Various different shapes of the upper and lower recesses 14c and 14d, when viewed from, e.g., above or below, respectively, are contemplated. Advantageously, and as shown in FIG. 1, the molded seat insert 14 has a first, e.g., forwardmost, upper recess 14c on the upper surface 14a of the molded seat insert 14 that has a pair of end regions 14g that each extend from a front edge 14e of the molded seat insert 14 towards a rear edge 14f of the molded seat insert 14. In the embodiment shown, for this same first upper recess 14c, the pair of end regions 14g do not extend fully to the rear edge 14f of the molded seat insert 14, but rather connect to a connection region 14h that extends generally parallel to the front and rear edges 14e, 14f of the molded seat insert 14.

Advantageously, and as also shown in FIG. 1, the molded seat insert 14 has a second, e.g., rearmost, upper recess 14c on the upper surface 14a of the molded seat insert 14 that has a pair of end regions 14i that each extend from opposing side edges 14k of the molded seat insert 14 towards a rear edge 14f of the molded seat insert 14. In the embodiment shown, for this same second upper recess 14c, the pair of end regions 14i do not extend fully to the rear edge 14f of the molded seat insert 14, but rather connect to a connection region 14j that extends generally parallel to the front and rear edges 14e, 14f of the molded seat insert 14.

Likewise, and as also shown in FIG. 1, the molded seat insert 14 has a third, e.g., intermediate, upper recess 14c on the upper surface 14a of the molded seat insert 14 that has a pair of end regions 14L that each extend from respective front corners 14m of the molded seat insert 14 towards a rear edge 14f of the molded seat insert 14. In the embodiment shown, for this same third upper recess 14c, the pair of end regions 14L do not extend fully to the rear edge 14f of the molded seat insert 14, but rather connect to a connection region 14N that extends generally parallel to the front and rear edges 14e, 14f of the molded seat insert 14.

Referring now to FIG. 6, the molded seat insert 14 may also have various shapes of its lower recesses 14d. For example, in the embodiment shown in FIG. 6, the lower surface 14b of the molded seat insert 14 has a first, e.g., forwardmost, lower recess 14d that has a pair of end regions 140 that each extend from the front edge 14e of the molded seat insert 14 towards a rear edge 14f of the molded seat insert 14. In the embodiment shown, for this same first lower recess 14d, the pair of end regions 140 do not extend fully to the rear edge 14f of the molded seat insert 14, but rather connect to a connection region 14p that extends generally parallel to the front and rear edges 14e, 14f of the molded seat insert 14.

Advantageously, and as also shown in FIG. 1, the molded seat insert 14 has a second, e.g., rearmost, lower recess 14d on the lower surface 14b of the molded seat insert 14 that has a pair of end regions 14q that each extend from opposing side edges 14k of the molded seat insert 14 towards a rear edge 14f of the molded seat insert 14. In the embodiment shown, for this same second lower recess 14d, the pair of end regions 14q do not extend fully to the rear edge 14f of the molded seat insert 14, but rather connect to a connection region 14r that extends generally parallel to the front and rear edges 14e, 14f of the molded seat insert 14.

Likewise, and as also shown in FIG. 1, the molded seat insert 14 has a third, e.g., intermediate, lower recess 14d on the lower surface 14b of the molded seat insert 14 that has a pair of end regions 14s that each extend from respective front corners 14m of the molded seat insert 14 towards a rear edge 14f of the molded seat insert 14. In the embodiment shown, for this same third lower recess 14d, the pair of end regions 14s do not extend fully to the rear edge 14f of the molded seat insert 14, but rather connect to a connection region 14t that extends generally parallel to the front and rear edges 14e, 14f of the molded seat insert 14.

With respect to the molded backrest insert 16, various different shapes of the front and back recesses 16c and 16d, when viewed from, e.g., the front or behind, respectively, are also contemplated. Advantageously, and as shown in FIG. 1, the molded backrest insert 16 has a first, e.g., uppermost, front recess 16c on the front surface 16a of the molded backrest insert 16 that has a pair of end regions 16g that each extend from a top edge 16e of the molded backrest insert 16 towards a bottom edge 16f of the molded backrest insert 16. In the embodiment shown, for this same first front recess 16c, the pair of end regions 16g do not extend fully to the bottom edge 16f of the molded backrest insert 16, but rather connect to a connection region 16h that extends generally parallel to the top and bottom edges 16e, 16f of the molded backrest insert 16.

Advantageously, and as also shown in FIG. 1, the molded backrest insert 16 also has a pair of second front recesses 16i on the front surface 16a of the molded backrest insert 16, one end of each extending from opposing side edges 16k of the molded backrest insert 16, and the other end extending to the bottom edge 16f of the molded backrest insert 16.

Likewise, and as also shown in FIG. 1, the molded backrest insert 16 has a third, e.g., intermediate, front recess 16c on the front surface 16a of the molded backrest insert 16 that has a pair of end regions 16L that each extend from respective upper corners 16m of the molded backrest insert 16 towards the bottom edge 16f of the molded backrest insert 16. In the embodiment shown, for this same third front recess 16c, the pair of end regions 16L do not extend fully to the bottom edge 16f of the molded backrest insert 16, but rather connect to a connection region 16N that extends generally parallel to the top and bottom edges 16e, 16f of the molded backrest insert 16.

Referring now to FIG. 6, the molded backrest insert 16 may also have various shapes of its back recesses 16d. For example, in the embodiment shown in FIG. 6, the back surface 16b of the molded backrest insert 16 has a first, e.g., uppermost, back recess 16d that has a pair of end regions 160 that each extend from the upper edge 16e of the molded backrest insert 16 towards a bottom edge 16f of the molded backrest insert 16. In the embodiment shown, for this same first back recess 16d, the pair of end regions 160 do not extend fully to the bottom edge 16f of the molded backrest insert 16, but rather connect to a connection region 16p that extends generally parallel to the top and bottom edges 16e, 16f of the molded backrest insert 16.

Advantageously, and as also shown in FIG. 6, the molded backrest insert 16 also has a pair of second back recesses 16q on the back surface 16a of the molded backrest insert 16, one end of each such back recess 16q extending from opposing side edges 16k of the molded backrest insert 16, and the other end extending to the bottom edge 16f of the molded backrest insert 16.

Likewise, and as also shown in FIG. 6, the molded backrest insert 16 has a third, e.g., intermediate, back recess 16d on the back surface 16b of the molded backrest insert 16 that has a pair of end regions 16s that each extend from respective upper corners 16m of the molded backrest insert 16 towards a bottom edge 16f of the molded backrest insert 16. In the embodiment shown, for this same third back recess 16d, the pair of end regions 16s do not extend fully to the bottom edge 16f of the molded backrest insert 16, but rather connect to a connection region 16t that extends generally parallel to the top and bottom edges 16e, 16f of the molded backrest insert 16.

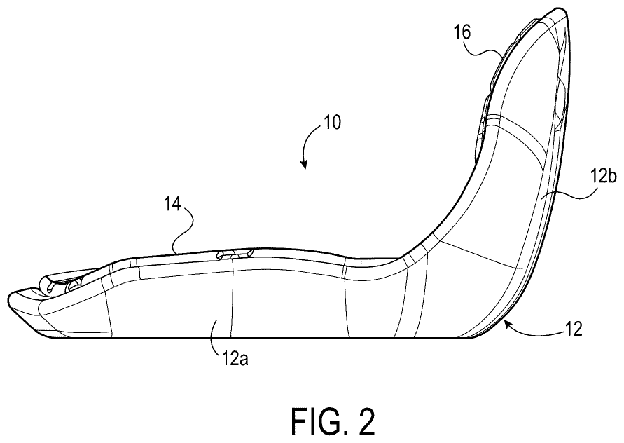

FIGS. 2 through 4 provide additional views of the molded seat 10, in accordance with various embodiments. For example, FIG. 2 is a side view of the molded seat 10, with the molded seat insert 14 seated within, or mounted, on e.g., fixedly attached to, the seat portion 12a of the molded seat pan 12, and with the molded backrest insert 16 connected to, or mounted on, e.g., fixedly attached to, the backrest portion 12b of the molded seat pan 12.

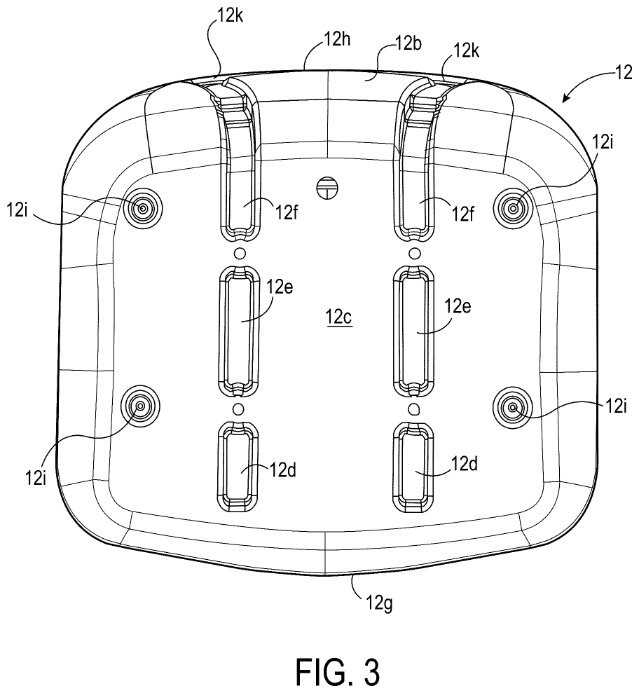

FIG. 3, on the other hand, is a bottom view of the molded seat 10, specifically of the bottom of the molded seat pan 12. As shown in FIG. 3, the molded seat pan 12 has a bottom surface 12c that defines various recesses therein. Various different recess configurations are contemplated, but in the embodiment shown in FIG. 3, the bottom surface 12c of the molded seat pan 12 includes a first pair of recesses 12d that are disposed on opposite sides of the molded seat pan 12 and that are located adjacent to the front edge 12g of the molded seat pan 12. FIG. 3 also shows the bottom surface 12c of the molded seat pan 12 having a second pair of recesses 12e that are also disposed on opposite sides of the molded seat pan 12 and that are located generally in a middle region between the front edge 12g and the rear edge 12h of the molded seat pan 12. Still further, FIG. 3 shows the bottom surface 12c of the molded seat pan 12 having a third pair of recesses 12f that are also disposed on opposite sides of the molded seat pan 12 and that are located adjacent to the rear edge 12h of the molded seat pan 12. This third pair of recesses 12f may also curve upwardly towards and onto a back surface of the backrest portion 12b of the molded seat pan 12 so as to form recesses 12k that provide support to the backrest portion 12b of the molded seat pan 12.

In the embodiment shown, the first, second and third pairs 12d, 12e, 12f of recesses are generally aligned with each other extending in the forward and backward directions from the front edge 12g of the molded seat pan 12 to the rear edge 12h of the molded seat pan 12. Of course, while the embodiment shown includes three pairs of bottom recesses on the bottom surface 12c of the molded seat pan 12, other numbers of recesses are also contemplated. Advantageously, and as will be explained in greater detail below, the recesses on the bottom surface 12c of the molded seat pan 12 are at least partially aligned with, e.g., intersect with, recesses formed by the molded seat insert 14 so as to provide additional support and cushioning.

FIG. 3 also shows that, in various embodiments, the bottom surface 12c of the molded seat pan 12 may include various seat pan connection regions 12i, which enable the seat pan 12 to be connected to another structure (not shown), such as the base of a stool, a lawnmower, or any other conceivable structure that could benefit from a seat thereon. Of course, any number or type of connection regions 12i are contemplated, including openings for bolts to pass therethrough, molded threaded portions, bolts extending therefrom, etc.

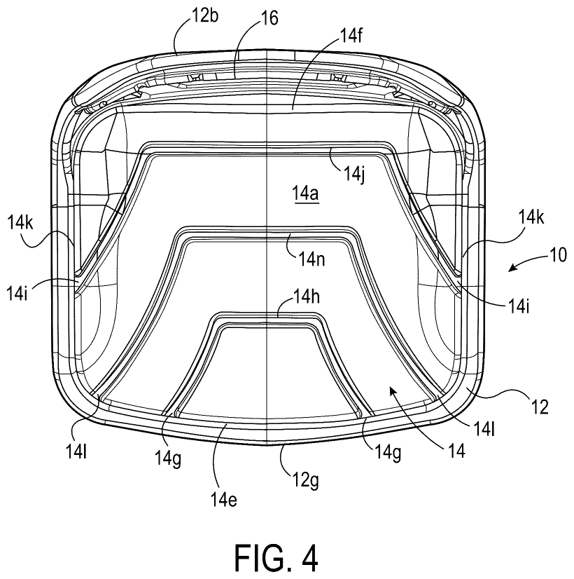

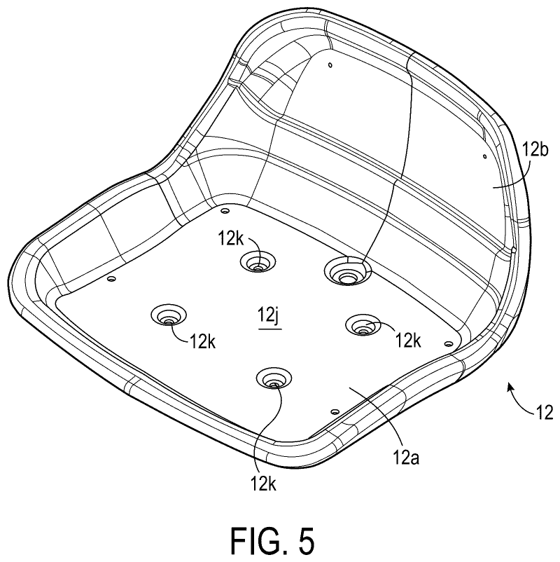

FIG. 4 is a top view of the molded seat of FIG. 1, in accordance with various embodiments. FIG. 5 is a front perspective view of the molded seat pan 12 of FIG. 1, having the molded seat insert 14 and the molded backrest insert 16 removed, in accordance with various embodiments. FIG. 5 shows the molded seat pan 12 having a top surface 12j on its seat portion 12a. FIG. 5 also shows that, in various embodiments, the top surface 12j of the molded seat pan 12 may include various seat insert connection regions 12k, which enable the molded seat insert 14 to be connected to the molded seat pan 12. Of course, any number or type of seat insert connection regions 12k are contemplated.

Turning now to FIG. 7, there is shown a side perspective view of the molded seat 10 of FIG. 1, having the molded seat pan 12 and with the molded seat insert 14 and molded backrest insert 16 mounted thereon. FIG. 7 shows the molded seat pan 12, the molded seat insert 14, and the molded backrest insert 16 in cross-section, so as to illustrate that, in various embodiments, the various recesses thereof may be at least partially aligned, and advantageously may be fully aligned, with each other so as to provide adequate support while still providing excellent cushioning to a user.

FIG. 7 illustrates that the front edge 14e of the molded seat insert 14 sits roughly adjacent to the front edge 12g of the molded seat pan 12, advantageously within a lip 12m formed by the front edge 12g of the molded seat pan 12. The rest of the molded seat insert 14 seats within the seat portion 12b of the molded seat pan 12.

As mentioned above, FIG. 7 illustrates that, in various embodiments, the various recesses formed in the upper and lower surfaces 14a, 14b of the molded seat insert 14 align with each other so that the respective bottom surfaces of the recesses formed thereby abut or touch each other and thereby provide additional support to the molded seat insert 14. For example, and as shown in FIG. 7, the recess 14h formed in the upper surface 14a of the molded seat insert 14 is aligned with, and is in contact with at least when sat upon, the recess 14p formed in the lower surface 14b of the molded seat insert 14. Likewise, the recess 14N formed in the upper surface 14a of the molded seat insert 14 is aligned with, and is in contact with at least when sat upon, the recess 14t formed in the lower surface 14b of the molded seat insert 14. Still further, the recess 14j formed in the upper surface 14a of the molded seat insert 14 is aligned with, and is in contact with at least when sat upon, the recess 14r formed in the lower surface 14b of the molded seat insert 14.

As also mentioned above, FIG. 7 illustrates that, in various embodiments, the various recesses formed in the front and back surfaces 16a, 16b of the molded backrest insert 16 align with each other so that the respective bottom surfaces of the recesses formed thereby abut or touch each other and thereby provide additional support to the molded backrest insert 16. For example, and as shown in FIG. 7, the recess 16h formed in the front surface 16a of the molded backrest insert 16 is aligned with, and is in contact with at least when leaned back upon by a user, the recess 16p formed in the back surface 16b of the molded backrest insert 16. Likewise, the recess 16N formed in the front surface 16a of the molded backrest insert 16 is aligned with, and is in contact with at least when leaned back upon by a user, the recess 16t formed in the back surface 16b of the molded backrest insert 16. In preferred aspects, the various interactions between the recesses provides the cushioning and reliance needed for a well cushioned seat without needing to fill the cavity inside the cushion parts with foam or other compressible materials of a similar nature. Thus, in preferred aspects, the interior cavity is hollow and due to the nature of blow molding there may be small holes therein which are used to pierce the parison during molding to introduce fluid into the parison to expand it against the mold. As a result, the recesses, their spacing between opposed recesses and that the recesses align such that they come into contact with each other to provide increasing resistance to compression as a user sits on the seat provides for the cushioned compliance without the expense and difficulty of filling the cavity with foam.

FIG. 8 is a front perspective view of the molded seat 10 of FIG. 1, having the molded seat pan 12 with the molded seat insert 14 and the molded backrest insert 16 mounted thereon. FIG. 8 also shows the molded seat pan 12, the molded seat insert 14 in cross-section, so as to illustrate—similar to FIG. 7 above—that, in various embodiments, the various recesses thereof may be at least partially aligned, and advantageously may be fully aligned, with each other so as to provide adequate support while still providing excellent cushioning to a user. In the view of FIG. 8, the recess 14L formed in the upper surface 14a of the molded seat insert 14 is aligned with, and is in contact with at least when sat upon, the recess 14s formed in the lower surface 14b of the molded seat insert 14. Although not expressly shown in this particular view due to the location of the cross-section, it should be appreciated that the other recesses formed in the upper surface 14a of the molded seat insert 14 may also be aligned with, and is in contact with at least when sat upon, the other recesses formed in the lower surface 14b of the molded seat insert 14.

In addition, in various embodiments, the recesses 12e formed on the bottom surface 12c of the molded seat pan 12 may also be at least partially aligned with recesses formed in the lower surface 14b of the molded seat insert 14. As shown in FIG. 8, the recesses 12e formed on the bottom surface 12c of the molded seat pan 12 intersect the connection recess 14N formed in the lower surface 14b of the molded seat insert 14, providing additional support thereto. Although not expressly shown in this particular view due to the location of the cross-section, it should be appreciated that the other recesses formed in the lower surface 12c of the molded seat insert 14 may intersect the other recesses formed in the lower surface 14b of the molded seat insert 14, providing still additional support.

Referring now to FIG. 9, there is shown a top perspective view of the molded seat 10 of FIG. 1, having the back portion 12b of the molded seat pan 12 and the molded backrest insert 16 shown in cross-section, in accordance with various embodiments. FIG. 9 also illustrates—similar to FIGS. 7 and 8 above—that, in various embodiments, the various recesses thereof may be at least partially aligned, and advantageously may be fully aligned, with each other so as to provide adequate support while still providing excellent cushioning to a user. In the view of FIG. 9, the recess 16i formed in the front surface 16a of the molded backrest insert 16 is aligned with, and is in contact with at least when leaned back upon by a user, the recess 16q formed in the back surface 16b of the molded backrest insert 16. Although not expressly shown in this particular view due to the location of the cross-section, it should be appreciated that the other recesses formed in the front surface 16a of the molded backrest insert 16 may also be aligned with, and is in contact with at least when leaned back upon by a user, the other recesses formed in the back surface 16b of the molded backrest insert 16. Although not shown in the view of FIG. 9 due to the location of the cross-section, the recesses 12k formed on the back surface of the backrest portion 12b of the molded seat pan 12 may also align with, or intersect with, other recesses 16d formed on the back surface 12b of the molded backrest insert 16 so as to provide additional support to the molded backrest insert 16 and the backrest portion 12b of the molded seat pan 12.

Referring to FIGS. 7 through 9 in particular, the various upper and lower recesses of the molded seat insert 14, as well as the front and back recesses of the molded backrest insert 16, are shown having generally channel-shaped, e.g., generally U-shaped, cross-sections. Of course, it should be appreciated that, while the various upper and lower recesses of the molded seat insert 14, as well as of the front and back recesses of the molded backrest insert 16, are shown having such generally channel-shaped cross-sections, the recesses may also have other cross-sectional shapes without limitation.

Referring specifically to FIG. 7, it may be noted that the lower recesses of the molded seat insert 14 may be deeper than the upper recesses of the molded seat insert 14. Having the recesses formed in the upper surface of the molded seat insert 14 be relatively shallow may provide the advantage of providing a generally more even seat surface, without large indentations which a user may sit on, and avoiding deep recesses into which personal belongings of a user may get lost or trapped. Of course, it should be appreciated that, while the lower recesses of the molded seat insert 14 are shown here as being deeper than the upper recesses, other relative depths of these recesses are also contemplated, without limitation.

As shown in FIG. 7, the three lower recesses 14p, 14t and 14r on the bottom surface 14b of the molded seat insert 14 have depths that are progressively deeper relative to each other towards a front edge 14e of the molded seat insert 14. These particular depths may provide additional rigidity and/or stiffness nearer to the rear edge 14f of the molded seat insert 14 where more of a user's weight may be supported, and additional softness and/or comfort nearer to the front edge 14e of the molded seat insert 14 where a user may feel discomfort in the legs after long periods of sitting on the molded seat insert 14. Of course, it should be appreciated that other relative depths of these recesses are also contemplated, without limitation.

As set forth above, the molded seat pan 10 may be molded from a variety of different molding materials, e.g., a thermoplastic material such as polyethylene, polypropylene, engineering grade resin or the like, without limitation. While all of the components (e.g., the molded seat pan 12, the molded seat inset 14 and the molded backrest insert 16) may be formed from the same thermoplastic material, embodiments are also contemplated in which the molded seat pan 12 is molded from a first thermoplastic and the molded seat insert 14 (or the molded backrest insert 16) is molded from a second thermoplastic, the first thermoplastic having a stiffness greater than a stiffness of the second thermoplastic so as to provide more support to the combined components when assembled and so as to enable the insert portions 14, 16 to provide additional cushioning. In embodiments, the molded seat insert 14 is made of a thermoplastic material having less density than the thermoplastic material used for the molded seat pan 12. The material used for the molded seat insert 14 may be selected such that the material is sufficiently flexible, soft, and elastic to provide cushioning and shock absorption protection for a user of molded seat 10 against seat movement and vibrations. In an exemplary embodiment, the molded seat pan 12 may be polyethylene and the molded seat insert 14 may be blended linear low-density polyethylene with 18% ethyl vinyl acetate.

As also mentioned above, any one or all of the molded seat pan 12, the molded seat insert 14 and the molded backrest insert 16 may be formed via molding processes such as vacuum forming or pressure forming, but may be particularly well-suited to be formed via a blow molding process (e.g., extrusion blow-molding, injection blow-molding, or stretch blow-molding). In such a process, molds may be provided having two separate portions, the cavities of which together have the shape of the molded seat pan 12, the molded seat insert 14 and/or the molded backrest insert 16. A thermoplastic material in a molten form is extruded between the mold halves, and the mold is closed around it, while fluid pressure is introduced so as to force the material against the walls of the cavities and into the shape of the molds. The pressure may be maintained until the molten material cools and solidifies. The pressure may then be released, the mold halves may be pulled apart, and the hardened article may be ejected therefrom.

In various embodiments, the molded seat insert 14 and/or the molded backrest insert 16 may have openings (not shown) to the external atmosphere, so as to be able to breathe, e.g., expel air from it interior to the external atmosphere, when sat upon. Alternatively, the molded seat insert 14 and/or the molded backrest insert 16 may be sealed, e.g., either at atmospheric pressure within its sealed interior, or pressurized within its sealed interior so as to provide still further cushioning when sat upon. The amount of pressure supplied to the molded seat insert 14 and/or the molded backrest insert 16 can be varied according to the amount of shock absorption desired.

In various embodiments, any or all of the molded seat pan 12, the molded seat insert 14 and the molded backrest insert 16 can be manufactured using any color of appropriate thermoplastic material and/or may include any design or logo thereon, enabling customizable branding.

It should be appreciated that, depending on various factors, e.g., the strength needed, the softness desired, the applications to be used under, etc., a thickness of the molded material used in the molded seat pan 12, the molded seat insert 14 and/or the molded backrest insert 16 can vary relative to each other, or the thickness of the material in different portions of the same component can vary. For example, an exemplary thickness of the molded material for any one or more of these components may be, e.g., 0.75 inches thick. Generally, given its role in supporting the seat 10, the thickness of the molded seat pan may be greater than other components, e.g., 1.5 inches.

Also contemplated is a method for producing the disclosed seat, comprising the steps of molding seat pan 111, molding seat insert 149, and connecting seat insert 153 with seat pan 112. FIG. 6. An additional optional step comprises connecting seat with seat base or vehicle 155.

Although the invention has been described with reference to a particular arrangement of parts, features and the like, these are not intended to exhaust all possible arrangements or features, and indeed many other modifications and variations will be ascertainable to those of skill in the art.

What is claimed is:

1. A molded seat comprising:
a molded seat pan having a seat portion;
a molded seat insert configured to engage the seat portion of the molded seat pan, the molded seat insert having a lower surface defining at least one lower recess and an upper surface defining at least one upper recess, the at least one upper recess and the at least one lower recess being at least partially aligned with each other.

2. The molded seat of claim 1, wherein the lower surface of the molded seat insert defines three lower recesses and the upper surface of the molded seat insert defines three upper recesses, the lower recesses being aligned with the upper recesses.

3. The molded seat of claim 1, wherein the molded seat pan has a backrest portion.

4. The molded seat of claim 3, further comprising:
a molded backrest insert mounted to the backrest portion of the molded seat pan.

5. The molded seat of claim 4, wherein the molded backrest insert has a back surface defining at least one back recess and a front surface defining at least one front recess, the at least one back recess and the at least one front recess being at least partially aligned with each other.

6. The molded seat of claim 5, wherein the back surface of the molded backrest insert defines three back recesses and the front surface of the molded backrest insert defines three front recesses, the back recesses being aligned with the front recesses.

7. The molded seat of claim 1, wherein the at least one lower recess and the at least one upper recess have channel-shaped cross-sections.

8. The molded seat of claim 7, wherein the at least one lower recess is deeper than the at least one upper recess.

9. The molded seat of claim 1, wherein the at least one lower recess and the at least one upper recess each include three recesses, and wherein the three upper recesses have a depth that is substantially the same as each other, and wherein the three lower recesses have depths that are progressively deeper relative to each other towards a front edge of the molded seat insert.

10. The molded seat of claim 1, wherein the at least one lower recess on the lower surface of the molded seat insert has a pair of ends that each extend from a front edge of the molded seat insert towards a rear edge of the molded seat insert.

11. The molded seat of claim 1, wherein the at least one lower recess on the lower surface of the molded seat insert has a pair of ends that each extend from opposite side edges of the molded seat insert towards a rear edge of the molded seat insert.

12. The molded seat of claim 1, wherein the at least one lower recess on the lower surface of the molded seat insert has a pair of ends that each extend from opposite front corners of the molded seat insert towards a rear edge of the molded seat insert.

13. The molded seat of claim 1, wherein the molded seat pan is molded from a first thermoplastic, and the molded seat insert is molded from a second thermoplastic, the first thermoplastic having a stiffness greater than a stiffness of the second thermoplastic.

14. The molded seat of claim 1, wherein at least one of the molded seat pan and the molded seat insert are blow-molded.

15. The molded seat of claim 1, wherein at least one of the molded seat pan and the molded seat insert are pressurized.

16. A molded seat insert configured to engage a seat pan, the molded seat insert comprising:
an upper surface defining at least one upper recess; and
a lower surface defining at least one lower recess,
wherein the at least one upper recess and the at least one lower recess are at least partially aligned with each other.

17. The molded seat insert of claim 16, wherein the lower surface of the molded seat insert defines three lower recesses and the upper surface of the molded seat insert defines three upper recesses, the lower recesses being aligned with the upper recesses.

18. The molded seat insert of claim 16, wherein the at least one lower recess and the at least one upper recess have channel-shaped cross-sections.

19. The molded seat insert of claim 16, wherein the at least one lower recess is deeper than the at least one upper recess.

20. The molded seat insert of claim 16, wherein the at least one lower recess and the at least one upper recess each include three recesses, and wherein the three upper recesses have a depth that is substantially the same as each other, and wherein the three lower recesses have depths that are progressively deeper relative to each other towards a front edge of the molded seat insert.

21. The molded seat insert of claim 16, wherein the at least one upper and lower recesses have a pair of ends that each extend from a front edge of the molded seat insert towards a rear edge of the molded seat insert.

22. The molded seat insert of claim 16, wherein the at least one upper and lower recesses have a pair of ends that each extend from opposite side edges of the molded seat insert towards a rear edge of the molded seat insert.

23. The molded seat insert of claim 16, wherein the at least one upper and lower recesses have a pair of ends that each extend from opposite front corners of the molded seat insert towards a rear edge of the molded seat insert.

24. The molded seat insert of claim 16, wherein the molded seat insert is molded from a thermoplastic.

25. The molded seat insert of claim 16, wherein the molded seat insert is blow-molded.

26. The molded seat insert of claim 16, wherein the molded seat insert is pressurized.
